(19) United States
(12) Patent Application Publication
(10) Pub. No.: US 2023/0277281 A1
(43) Pub. Date: Sep. 7, 2023

(54) DUAL-FUNCTION SEAL

(71) Applicant: Pinchas Kfir, Petach-Tikva (IL)

(72) Inventors: Pinchas Kfir, Petach-Tikva (IL); Ohad Henn, Ramat Gan (IL); Sefi Shachrur, Pardes Hana Karkur (IL)

(21) Appl. No.: 18/004,375

(22) PCT Filed: Jul. 15, 2021
(86) PCT No.: PCT/IB2021/056385

§ 371 Date: Jan. 5, 2023

Related U.S. Application Data
(60) Provisional application No. 63/051,990, filed on Jul. 15, 2020.

(51) Int. Cl. A61C 8/00

(52) U.S. Cl. CPC A61C 8/0089; A61C 8/0024; A61C 8/006; A61C 8/0068; A61C 8/0037

(57) ABSTRACT

Apparatus including a seal (100) is provided for use with a dental implant (200). The seal has a cross-section defining a high-load bearing portion (320) and a low-load bearing portion (340) angled in relation to each other, the high-load bearing portion being configured to apply a pressure that is greater than a pressure applied by the low-load bearing portion. A surface area of the high-load bearing portion is smaller than a surface area of the low-load bearing portion. Other applications are also described.

### CROSS-REFERENCES TO RELATED APPLICATIONS

The present application claims priority from U.S. Provisional Patent Application No. 63/051,990 to Kfir et al., filed Jul. 15, 2020, entitled “Dual-Function Seal”, which is incorporated herein by reference.

### FIELD OF THE INVENTION

Some applications of the present invention generally relate to devices and methods for use with medical implants, and more specifically to devices and methods for use with dental implants.

### BACKGROUND

Implant dentistry has become one of the most successful dentistry techniques for replacing missing teeth. However, peri-implantitis is a later complication of implant dentistry, that if untreated can lead to implant loss. One of the causes of peri-implantitis is bacterial leakage between segments of the implant, for example, at the implant-abutment interface. Generally, microbial growth is observed in many dental implants and various configurations of implant-abutment connections. Bacterial leakage often occurs at micro gaps at the implant-abutment interface level, allowing microorganisms to penetrate and colonize the inner part of the implant thereby creating a bacterial reservoir, followed by bacterial leakage to the surroundings of the implant, leading to development of peri-implantitis. Peri-implantitis is associated with a high inflammatory cell infiltration and bone loss.

Prevention of bacterial leakage at the level of the implant-abutment interface or at the interface between segments of segmented implant systems is an important goal during construction of a new multiple piece implant systems (e.g., two-piece or multiple-pieces implant systems), in order to reduce the probability of peri-implantitis and implant loss. Therefore, blocking passage of bacteria in implant systems is important for preventing peri-implantitis.

### SUMMARY

Some applications of the present invention provide apparatus for use with a dental implant, the apparatus comprising a seal/gasket configured to seal a connection or interface between portions of an implant, e.g., a dental implant. More specifically, the seal provided by some applications of the present invention, is configured to seal the interface between any two connected portions of a dental implant, e.g., between segments of a segmented dental implant and/or between the implant head and any type of abutment, connector, adapter, multi-unit or any part attachable to a crown, bridge or denture to be attached to the implant (supra-structure). It is noted that the terms seal, dual function seal, and gasket are used interchangeably herein.

In some applications, the seal is configured to seal the interface between the two portions of the implant, thereby reducing or completely preventing bacterial leakage into the interface between the two portions of the implant, and into the implant. For example, in some cases of a dental implant, the seal is configured to seal the interface between the implant head and the abutment, thereby reducing or completely preventing bacterial leakage into micro gaps at the implant-abutment interface level.

In accordance with some applications of the present invention, the seal has a dual sealing functionality by comprises at least two sealing portions each having a distinct sealing functionality. Typically, the seal is characterized by having a cross-section defining a high-load bearing portion and a low-load bearing portion angled in relation to each other thereby creating a double barrier.

Typically, a surface area of the high-load bearing portion is smaller than a surface area of the low-load bearing portion (the low-load bearing portion having a surface area that is greater than the surface area of the high-load bearing portion). In some applications, the surface area of the low-load bearing portion is at least twice the surface area of the high-load bearing portion.

Sealing of spaces and gaps between segments of the implant using the seal in accordance with some applications of the present invention, is based on (i) the relatively large area-low pressure portion of the seal in which the sealing material fills pores in the structure (e.g., implant and/or abutment) surface over a relatively large surface area, and (ii) a relatively small area-high pressure seal in which the sealing material is tightly compressed against a surface of the structure (e.g., implant and/or abutment) over a relatively small surface area. This combination provides a tight and effective sealing in multiple planes and axes of the interval between the connected portions of the implant.

There is therefore provided in accordance with some applications of the present invention, apparatus for use with a dental implant, the apparatus including:

a seal having a cross-section defining a high-load bearing portion and a low-load bearing portion angled in relation to each other, the high-load bearing portion being configured to apply a pressure that is greater than a pressure applied by the low-load bearing portion;

a surface area of the high-load bearing portion is smaller than a surface area of the low-load bearing portion.

For some applications, the high-load bearing portion is configured to apply pressure to the implant along a surface area of the implant that is smaller than a surface area of the implant to which the low-load bearing portion applies pressure to.

For some applications, the high-load bearing portion is configured to apply a pressure that is at least twice the pressure applied by the low-load bearing portion

For some applications, the low-load bearing portion is configured to apply pressure to the dental implant along a surface area of the implant such that sealing material of the seal fills pores in the implant.

For some applications, a ratio between the surface area of the low-load bearing portion and the surface area of the high-load bearing portion is 3:2.

For some applications, a ratio between the surface area of the low-load bearing portion and the surface area of the high-load bearing portion is 4:3.

For some applications, a ratio between the surface area of the low-load bearing portion and the surface area of the high-load bearing portion is 2:1.

For some applications, the cross-section of the seal is L-shaped.

For some applications, the seal is sized and shaped to be accommodated between a dental implant and an abutment.

For some applications, the seal is sized and shaped to be accommodated between at least two parts of a dental implant.

For some applications, the seal is sized and shaped to be accommodated between at least two of: dental implants screws, abutments, supra structures or other dental implant parts.

For some applications, the seal is sized and shaped to be accommodated between at least two parts of a medical implant.

For some applications, the seal is sized and shaped to be accommodated between at least two of: medical implant screws, supra-structures, or other medical implant parts.

For some applications, the seal is sized and shaped to be accommodated between at least two implant parts connected by a screw.

For some applications, the seal is sized and shaped to be accommodated between at least two implant parts connected by friction.

For some applications, the seal is sized and shaped to be accommodated between at least two implant parts connected by a shape of connection selected from the group consisting of: an internal connection, an external connection, a hexagonal connection, and a conical connection.

The present invention will be more fully understood from the following detailed description of embodiments thereof, taken together with the drawings, in which:

### BRIEF DESCRIPTION OF THE FIGURES

FIG. 1 is a schematic illustration of a seal for use with dental implant, in accordance with some applications of the present invention;

FIG. 2 and FIG. 3 are schematic illustrations indicating pathways through which bacteria may leak into the dental implant;

FIG. 4, FIG. 5, and FIG. 6 are schematic illustrations of the seal for use with the dental implant, illustrating the dual sealing functionality of the seal, in accordance with some applications of the present invention;

FIG. 7 is a schematic illustration of the seal for use with the dental implant, depicting positioning of the seal between the dental implant and an abutment prior to tightening, in accordance with some applications of the present invention;

FIG. 8 is a schematic illustration of the seal for use with the dental implant, depicting positioning of the seal between the dental implant and an abutment subsequently to tightening, in accordance with some applications of the present invention; and

FIG. 9A, FIG. 9B, and FIG. 9C are schematic illustrations of additional possible configurations and orientations of the seal, in accordance with some applications of the present invention; and

FIGS. 10A and 10B are schematic illustrations of additional possible configurations and orientations of the seal, in accordance with some applications of the present invention; and

FIGS. 11A and 11B are photographs depicting an experiment performed in accordance with some applications of the present invention.

### DETAILED DESCRIPTION

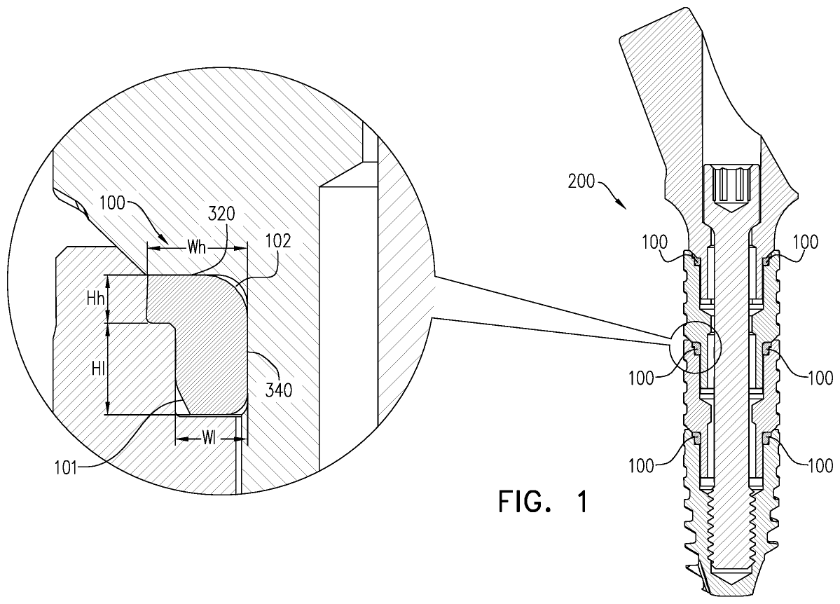

FIGS. 1-8 are schematic illustrations showing seal 100 for use with dental implant 200 in accordance with some applications of the present invention. As described hereinabove, seal 100 is configured to seal any interface between portions of dental implant 200. For example, seal 100 is configured to seal a connection between segmented portions of the dental implant, and/or between the dental implant and a supra-structure such as an abutment.

In accordance with some applications of the present invention, seal 100 is configured for use with connectors and parts of all types. Seal 100 is configured for use with implant elements made of any type of material e.g., titanium, zirconia, titanium-zirconia or any other material or combination of materials.

In accordance with some applications of the present invention, seal 100 is configured for use with different connection interfaces between any two segments of implant 200, for example, between the implant head and any type of supra structure, and/or between each segment of the implant and an adjacent part such as a hexagonal, conical, and cage-shaped part.

In accordance with some applications of the present invention, seal 100 may be used with any external or internal connection interfaces between any two segments of implant 200, for example, between the implant head and any type of supra structure and/or between any implant part and the adjacent part such as internal hexagonal connection interfaces (internal hexagonal) and/or connection interfaces of external hexagonal, and/or conical or cube interfaces, or combination thereof.

In accordance with some applications of the present invention, seal 100 may be used with any connection interface between any two segments of the implant, for example, between the implant head and any type of supra-structures, and/or any part of implant 200 adjacent to it with any contact and/or grip between the parts. For example, connecting with friction in threaded connection and/or combination between friction and threaded connection in “click” between part and part, connection by means of a tightening screw between the parts and without a screw tightening between the parts.

For some applications, seal 100 is sized and shaped to be positioned between at least two implant parts connected by a screw (or any other connecting element). For some applications, seal 100 is sized and shaped to be positioned between at least two parts of implant 200 that are connected by friction. Typically, the functionality of seal 100 is generally not affected by a degree of tightness of the connection (e.g., a screw) between the implant segments.

In accordance with some applications of the present invention, seal 100 may be made of different materials or a compound of different materials. For some applications, seal 100 comprises a flexible, biocompatible polymeric material such as an elastomer (e.g., a deformable elastomer). Alternatively, or additionally, seal 100 comprises a shape memory alloy, e.g., nitinol. Further additionally, or alternatively, seal 100 may be applied together with additives e.g., agents applied locally, such as antibacterial supplements, an adhesive material, etc.

In accordance with some applications of the present invention, seal 100 may be shaped to define various geometric shapes such as circle or hexagon, and different cross section shapes. Additionally, or alternatively, seal 100 may vary in thickness, diameter, and height.

For some applications, seal 100 is shaped to define more than four surfaces. In accordance with some applications of the present invention, seal 100, shown in FIGS. 1-8 has an L-shaped cross section. It is noted that the L-shaped cross section is shown by way of illustration and not limitation. It is noted that seal 100 may have other cross-sectional shapes, in accordance with some applications of the present invention. For some applications, the L-shaped cross-section typically facilitates placement and insertion of the seal.

Reference is now made to FIG. 1, which shows dental implant 200 being used with seal 100, of which an exploded cross-sectional view is shown. Seal 100 is configured to seal an interface between any two connected parts of dental implant 200, to reduce or completely prevent bacterial leakage into the interface between the two portions of dental implant 200, and infiltrate into the body of dental implant 200.

For some applications, seal 100 comprises a high-load bearing portion 320 and a low-load bearing portion 340 angled in relation to each other.

As shown, a surface area of high-load bearing portion 320 is typically smaller than a surface area of the low-load bearing portion 340 (low-load bearing portion 340 having a surface area that is greater than the surface area of high-load bearing portion 320). In some applications, the surface area of the low-load bearing portion is at least 1.5, or 2 times the surface area of the high-load bearing portion.

As described hereinabove, seal 100 comprises a dual sealing functionality when deployed to seal the interface between two portions of dental implant 200. Typically, when seal 100 is deployed to seal the interface between two portions of dental implant 200, low-load bearing portion 340 applies relatively low pressure to the implant structure along a relatively large surface area such that the sealing material fills pores in the structures of implant 200 (e.g., the implant fixture and/or the abutment) surface. Additionally, when seal 100 is deployed to seal the interface between two portions of dental implant 200, high-load bearing portion 320 applies relatively high pressure to the structures of implant 200 along a relatively small surface area such that the sealing material is tightly compressed against the surface of structures of implant 200 (e.g., the implant fixture and/or abutment) over a relatively small surface area. This combination provides a tight and effective seal in multiple planes and axes of the interface between the two or more connected portions of dental implant 200.

FIG. 1 shows seal 100 being shaped to define a ring shaped (e.g., an O-ring shape) having an L-shaped cross-section, such that, low-load bearing portion 340 has a height Hl that is greater than a height Hh of high-load bearing portion 320. For example, a ratio between height Hl of low-load bearing portion 340 and height Hh of high-load bearing portion 320 is at least, or greater than, 3:2. For some applications, a ratio between height Hl of low-load bearing portion 340 and height Hh of high-load bearing portion 320 is at least, or greater than, 4:3. For some applications, height Hh of high-load bearing portion 320 is 3-6 mm, and height Hl of low-load bearing portion 340 is 4-8 mm.

For some applications, seal 100 has a total width of 0.25-10 mm, e.g., 0.25-2 mm, 2-3 mm, 3-6 mm, or 6-10 mm. For some applications, a width Wl of low-load bearing portion 340 is less than a width Wh of high-load bearing portion 320. For example, a ratio between width Wh of high-load bearing portion 320 and width Wl of low-load bearing portion 340 is at least, or greater than, 3:2. For some applications, a ratio between width Wh of high-load bearing portion 320 and width Wl of low-load bearing portion 340 is at least, or greater than, 4:3.

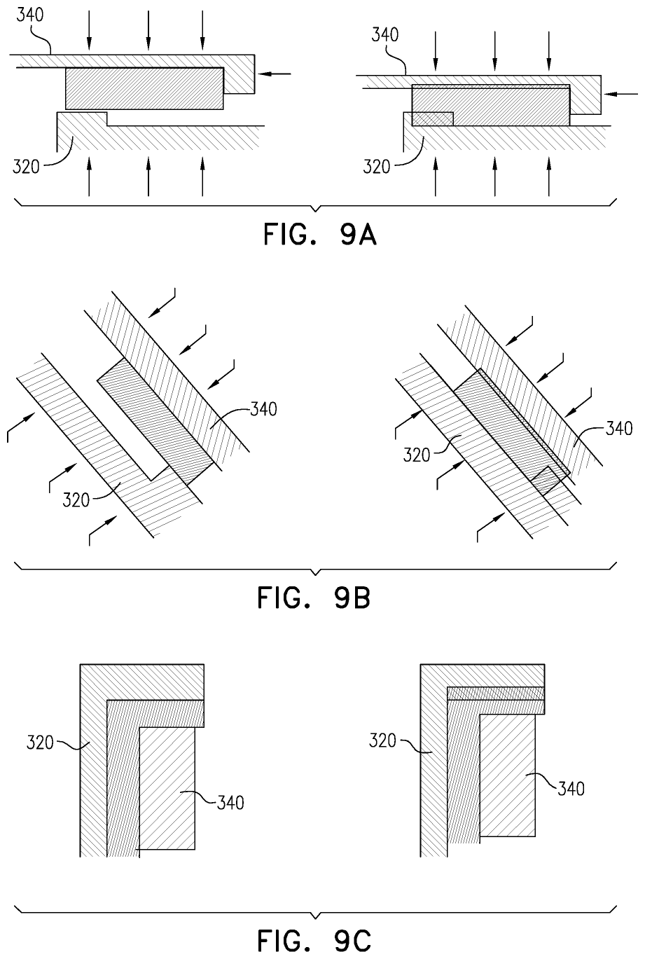

It is noted that the above-mentioned ratios are maintained at various configurations and orientations of seal 100 (e.g., as shown in FIGS. 9A-C and 10A-B).

Additionally, and optionally, seal 100 may have cut-outs 101 and/or 102 to facilitate an easy fit inside a pre-made groove to allow room for spreading of the seal under compressive forces when a connection of segments of the dental implant is tightened.

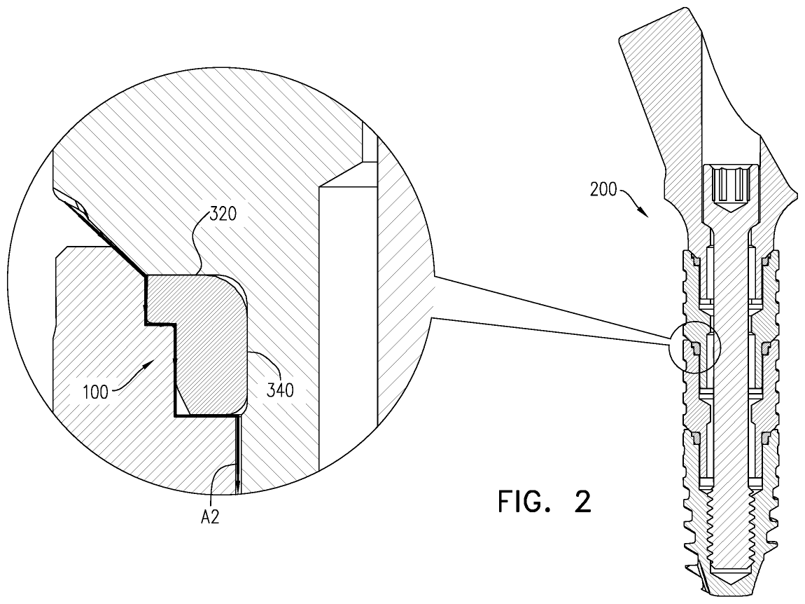

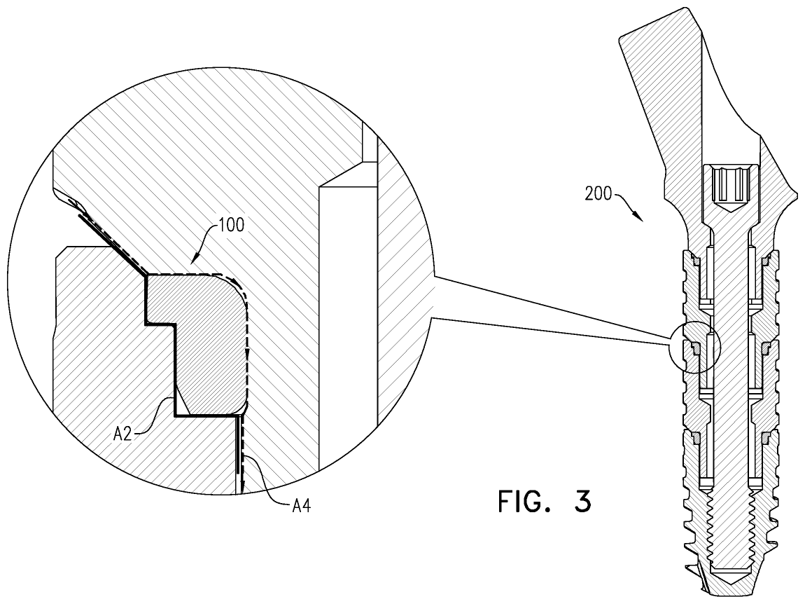

Reference is now made to FIG. 2 and FIG. 3, which are schematic illustrations indicating potential pathways through which bacteria (germs) may leak into the dental implant. Typically, any connection between dental implant parts and segments, regardless of the tightness of the connection, leaves a pathway for bacteria to penetrate into dental implant 200. As described above, infiltration of bacteria may lead to infection and inflammation resulting in loosening of dental implant 200. Potential bacterial pathways are indicated by arrows A2 and A4 in FIG. 2 and FIG. 3 by way of illustration (A4 represented by the dashed-line arrow in FIG. 3). However, it is typically the case that with seal 100 in place, leakage of bacteria into dental implant 200 is typically reduced or completely prevented.

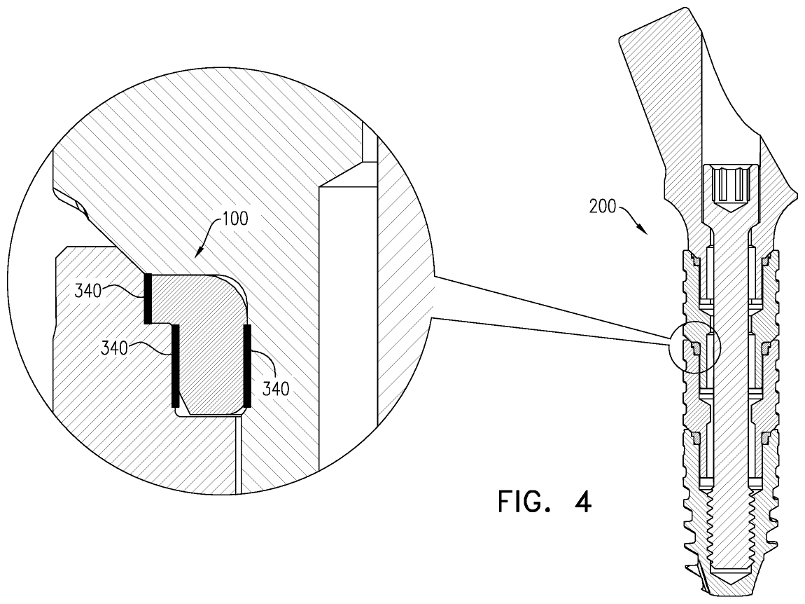

Reference is now made to FIG. 4, FIG. 5, and FIG. 6, which are schematic illustrations of seal 100 for use with dental implant 200, demonstrating the dual sealing functionality of seal 100, in accordance with some applications of the present invention. As described herein, the dual sealing functionality of seal 100 effects proper sealing of interfaces between portions of dental implant 200 in order to reduce or and prevent bacterial leakage. As shown in FIGS. 4-6, seal 100 provides both radial sealing and axial sealing thereby achieving optimal sealing of the connection between two parts of dental implant 200.

As shown in FIGS. 4-6, sealing of the spaces and gaps between two surfaces of dental implant 200 using seal 100 in accordance with some applications of the present invention, is based on (i) a relatively large area-low pressure portion of the seal in which the sealing material fills pores in structure of dental implant 200 (e.g., the implant fixture and/or the abutment) surface over a relatively large surface area (indicated by reference numeral 340 in FIG. 4), and, (ii) a relatively small area-high pressure seal in which the sealing material is tightly compressed against a surface of a structure of dental implant 200 (e.g., the implant fixture and/or the abutment) over a relatively small surface area (indicated by reference numeral 320 in FIG. 5). This combination provides both radial and axial sealing of the gap between two surfaces being sealed as shown in FIG. 6, which provides sealing not only of the horizontal and/or vertical surfaces, but also of an angular surface along which the two surfaces (e.g., of the abutment and dental implant 200) slide when the connection between them is tightened. Reference numeral 602 in FIG. 6 refers to the sliding gap between the abutment and the implant. Arrows 322 and 344 indicate the pressure applied to implant 200 by portions 320 and 340, respectively. In some applications, the pressure applied by high bearing portion 320 is at least 1.5, or 2 times greater than the pressure applied by the low bearing portion 340.

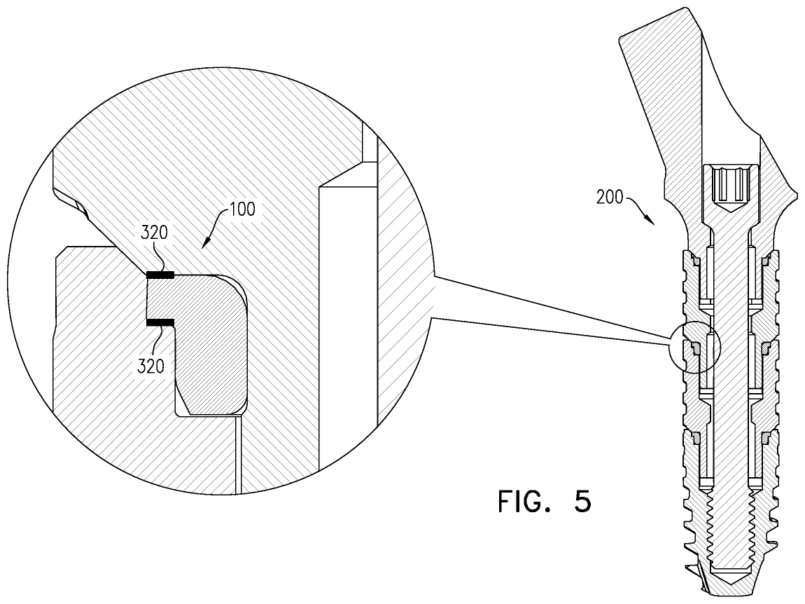

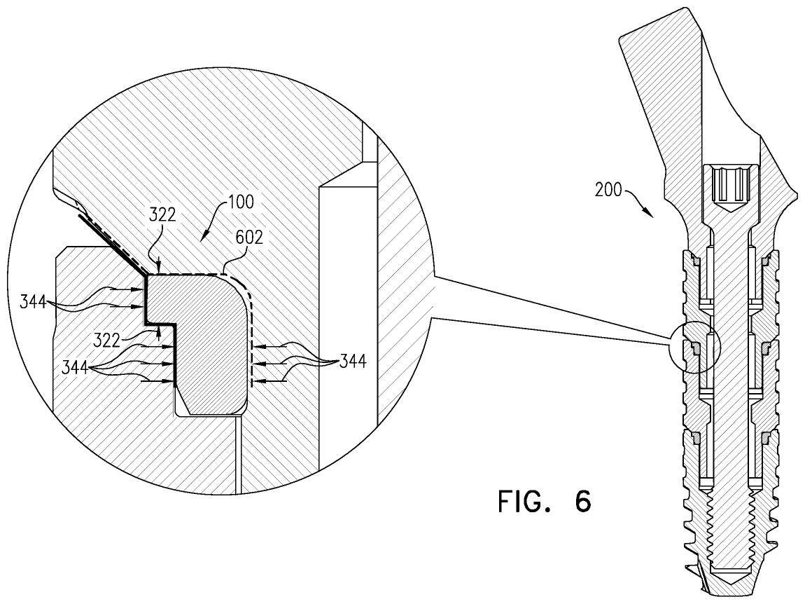

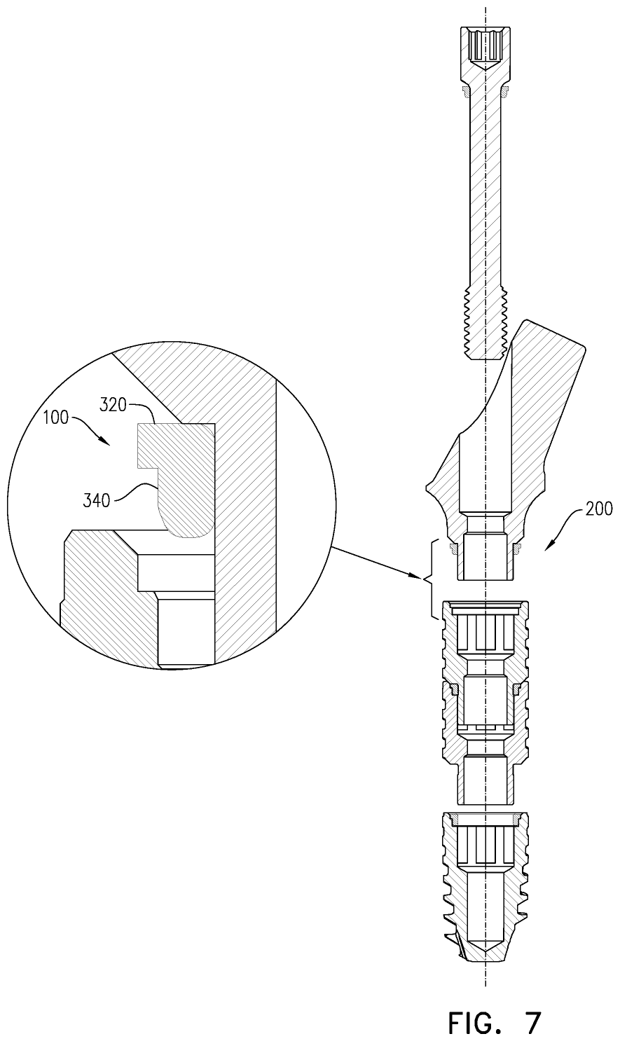

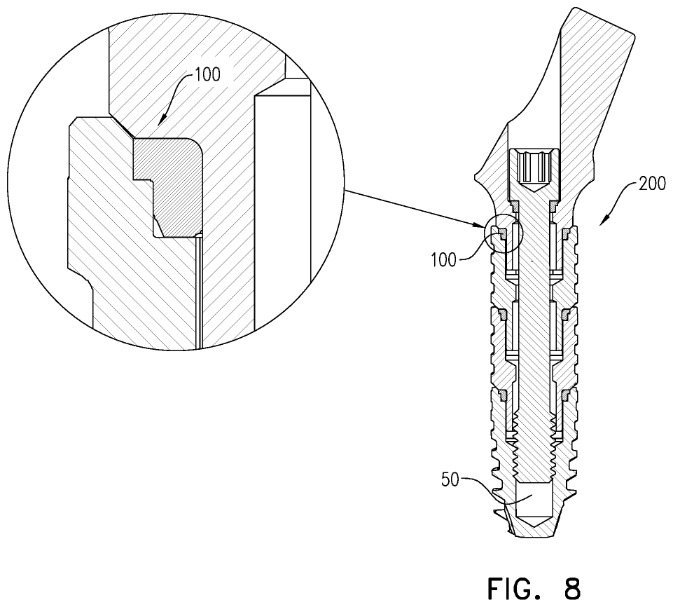

Reference is now made to FIG. 7 and FIG. 8.

FIG. 7 is a schematic illustration of seal 100 further depicting positioning of seal 100 between dental implant 200 and an abutment prior to tightening, in accordance with some applications of the present invention. More specifically, FIG. 7 shows positioning of seal 100 between a screw head and an abutment prior to tightening with the screw. FIG. 8 is a schematic illustration of seal 100 further depicting positioning of seal 100 between dental implant 200 and an abutment subsequently to tightening, in accordance with some applications of the present invention. More specifically, FIG. 8 shows positioning of seal 100 between a screw head and an abutment subsequently to tightening with the screw.

Reference is now made to FIG. 9A, FIG. 9B, and FIG. 9C, which are schematic illustrations of additional possible configurations and orientations of seal 100, in accordance with some applications of the present invention. FIGS. 9A-9C show examples of seal 100 having a low-pressure/high surface area (portion 340 of seal 100) and high-pressure/low surface area (portion 320 of seal 100). In some cases, two seals may be provided one for each function. The arrows in FIGS. 9A, FIG. 9B, and FIG. 9C generally indicate the direction in which pressure is applied to the implant by portions 320/340.

FIG. 9A illustrates a disc-type seal 100, in accordance with some applications of the present invention. As shown, for some applications, portion 320 comprises a step, thereby changing the percentage of the sealing surface area.

FIG. 9B illustrates an angled seal 100, in accordance with some applications of the present invention.

FIG. 9C illustrates seal 100 having a reversed L-shape angled seal, in accordance with some applications of the present invention.

It is noted that generally, the dual function of seal 100 is affected by the ratio between the surface area of the axial (low-pressure) sealing portion 340, and the surface area of the radial (high-pressure) sealing portion 320. For some applications, a ratio between the surface area of axial, low-load bearing portion 340 and the surface area of radial high-load bearing portion 320 is at least, or greater than, 3:2. For some applications, a ratio between the surface area of low-load bearing portion 340 and the surface area of high-load bearing portion 320 is at least, or greater than, 4:3. For some applications, a ratio between the surface area of low-load bearing portion 340 and the surface area of high-load bearing portion 320 is 2:1.

Reference is made FIGS. 10A and 10B, which show additional possible configurations and orientations of seal 100, in accordance with some applications of the present invention. As shown, for some applications, seal 100 is shaped to define corner cut-outs 101 and/or 103 (as also shown by cut-outs 101 and 102 in FIG. 1), which typically facilitate an easy fit inside a pre-made groove to allow room for spreading of the seal under compressive forces when a connection of segments of the dental implant is tightened. These cuts typically focus the sealing effect to a single point.

Additional factors affecting the dual function of seal 100, include the size and angle of these corner cuts, e.g., cut-out 101 at the edge of the axial (low-pressure) sealing surface (FIG. 10A), and the size and angle of corner cut 103 at the edge of the radial (high-pressure) sealing surface (FIG. 10B).

Reference is again made to FIGS. 1-10B.

In general, seal 100 is configured for use with any implant configuration. Typically, the shape and dimensions of seal 100 can be varied to accommodate use with a variety of implant configurations. Generally, it is easier and shorter in terms of times to make a change to the seal geometry or to produce some test templates, than to change the implant design. Therefore, the changes made in seal 100 itself, saves time and cost, rendering seal 100 cost effective and easy to use.

Generally, an L-shaped seal 100 as shown in FIGS. 1-10B facilitates easy insertion and placement of seal 100. It is noted that other shapes of seal 100 may also provide easy insertion and placement. Apart from insertion and placement, the shape of seal 100 provides sealing when the dental implant part is not necessarily centered (due to chewing, tooth pressure by the patient, etc.) and reduces the risk of seal 100 breaking, as well as change the compression relative percentage of each parameter without compromising other sealing functions. In other words, seal 100 as provided by applications of the present invention, is especially configured for use with a dynamic dental implant that undergoes movement e.g., in response to chewing.

Reference is still made to FIGS. 1-10B.

Seal 100 provided in accordance with some applications of the present invention, is generally indifferent to the gaped interface between the two parts of dental implant 200, which is sealed by seal 100. In other words, the seal is configured to seal the interface/gap between connected portions of the implant to seal any type, shape or size of gap between the connected portions.

In accordance with some applications of the present invention, groove and seal design are generally not affected by tightness of attachment between segments of the dental implant and ensure sealing under varied conditions.

In accordance with some applications of the present invention, seal 100 provides dual safety by radial and axial two-surface sealing between the implant parts.

In accordance with some applications of the present invention, seal 100 is generally not sensitive to the orientation of the two parts of the implant in relation to one another. In other words, seal 100 is configured to seal the connection between two portions of the dental implant regardless of the orientation of the dental implant portions with respect to one another.

In accordance with some applications of the present invention, seal 100 self-seals in place during attachment of the dental implant parts.

In accordance with some applications of the present invention, a high polish mold and low shore allows seal 100 to fill the gaps and the micro dents of the surface, thereby preventing infiltration and passage of microorganisms.

### EXPERIMENTAL DATA

The experiments described hereinbelow were performed by the inventors in accordance with applications of the present invention and using the apparatus and techniques described herein.

A series of laboratory experimentations are described hereinbelow which may be used separately or in combination, as appropriate, in accordance with applications of the present invention. It is to be appreciated that numerical values are provided by way of illustration and not limitation. Typically, but not necessarily, each value shown is an example selected from a range of values that is within 10% of the value shown. Similarly, although certain steps are described with a high level of specificity, a person of ordinary skill in the art will appreciate that other steps may be performed, mutatis mutandis.

The experiments described hereinbelow with reference to Examples 1-2 were performed using the seal provided in accordance with some applications of the present invention.

### Example 1: Pressure Test

In accordance with some applications of the present invention, a pressure test was conducted to test resilience of the seal following sterilization by Gamma radiation.

### Results:

### Burst After Gamma

| # | Result |
|---|---|
| 1 | Held Up to 4 bar 12 min, connection broke |
| 2 | Held 3 bar for 15 min, connection broke |
| 3 | Held Up to 4 bar 5 min, connection broke |
| 4 | Held 3 bar for 11 min, connection broke |
| 5 | Held 3 bar for 13 min, connection broke |

### Conclusion:

No Burst was achieved, and the seal withstood the applied pressure. All failures, and broken connections occurred as a result of the air insertion interface.
Gamma sterilization has little to no effect on the seal.
In real life the pressure within the implant is generally low (<1.5 bar), so it is expected, and reasonable based on the results of this experiment that the seal should maintain its integrity when implanted.

### Example 2: In Vitro Bacterial Leakage Tests

In accordance with some applications of the present invention, various experiments were performed to examine possible leakage from an interval (gap) between connected implant parts.

All of the experimental dental implants tested were MtDI—Ø3.75/L13.5 mm (Ti 6Al-4V Lot No. 131011)—modular dental implants with dental implant sealer apparatus: 03.75 L6.5 mm Apex, two Ø3.75 L3.5 mm Rings, mount and mount screw, supplied by Zeev Implants Ltd.

Both control experiments and experiments using seal 100, in accordance with applications of the present invention, as described hereinbelow.

### Control Experiments:

Prior to the experiments testing the seal of the present invention, two types of control experiments were conducted.

1) Control Experiment—Type 1:

Prior to the experiments testing the seal in accordance with applications of the present invention, a bacterial transfer test was performed in the dental implant. In this experiment no gaskets or seals were used to seal connections between the implant parts in order to confirm that bacterial leakage indeed occurs in the absence of any sealing elements. As expected, the results of these experiments showed that bacteria infiltrated and infected all of the implants tested in the absence of sealing elements.

2) Control Experiment—Type 2:

Prior to the experiments testing the seal in accordance with applications of the present invention, an air leakage test was performed in the dental implant using a simple silicone ring as a seal. The inventors hypothesized that air leakage would be indicative of bacterial leakage in the implant. In this experiment a standard silicone O-RING ring was used as a gasket for sealing portions of the implant.

Air leakage experiment was performed by pressure air being introduced through a tube connected to the implant 1.8 bar 260N.

Results: After 45K cycles the experiment failed—the standard silicone ring did not seal the parts of the implant and air leaked between the parts due to implant deformity.
Conclusions: the standard silicone O-RING ring did not provide the necessary sealing to prevent air leakage, which is indicative that the standard silicone O-RING does not provide the sealing required for prevention of bacterial leakage in the implant.
Experiments Using Dual-Function Seal 100 in Accordance with Some Applications of the Present Invention:

The following experiments were performed to test the hypothesis that dual seal 100 will seal the interface between the implant parts, in accordance with some applications of the present invention.

First, two types of bacteria-free experiments were conducted in order to test the seal of the present invention: air leakage and paint leakage. These experiments are described below:

### a) Bacteria-Free Test: Testing Air Leakage:

Experiments to test high-pressure air leakage into the implant, with/without the application of static and dynamic (cyclic) forces at an angular structure attached to the implant head.

Dynamic experiment—applying cyclic force to the implant with the current gasket (i.e., seal 100):
Purpose of the tests—To examine whether a variable force exertion has a change in sealing.
1. Checking 75K Cycles 1.5 bar 150N—There was no air leak. The examination saw a change in the orientation of the parts (showing that the orientation between the parts does not impair the sealing). After 75 cycles, there was a fracture in the JIG that gripped the implant.
2. Checking 84K cycles 1.5 bar 200N
3. Checking 92.7K cycles, 230N, 1.5 bar
   * The difference between the tests is the force exerted on the system—a test with varying forces on the implant.
   Results: None of the tests showed an air leak.
   b) Bacteria-Free Test: Testing of Paint/Dye Leakage from Implant

Paint leakage from the implant was tested while using the seal of the present invention (seal 100), the occurrence of paint leakage being indicative of possible bacterial leakage from the implant. In the experiment, the central screw of the implant was removed, and 5 μl of Bromophenol blue paint material (3′, 3″, 5′, 5″-tetrabromophenolsulfonphthalein, BPB, albutest)) liquid dye was added into a small cavity at the bottom of the implant. The central screw was then put in place. For example, the liquid dye is disposed in the portion of the dental implant that is indicated by reference numeral 50 in FIG. 8. Subsequently, to putting the central screw in place, the dental implant was placed in a container with saline fluid (9% sodium chloride), and possible paint leakage was tested following 5 minutes.

Results: following 5 minutes at room temperature—no leakage of dye was observed. In other words, the seal of the present invention provided sealing that prevented paint leakage from the implant.

In a parallel experiment, an implant without use of a gasket seal was tested for dye leakage. In this experiment dye leakage was observed immediately after inserting the color into the implant.

### C. Bacteria Leak Test

Bacterial leakage from the dental implant was tested while using seal 100, in accordance with some applications of present invention. In this set of experiments, after the central screw was removed, bacteria were inserted into the implant and the central screw was replaced—in repeated tests for the duration of 30 days.

In one set of experiments, bacteria leakage out of the dental implant was tested in the absence of any force applied to the implant. In a second set of experiments, bacterial leakage from the implant was tested while applying force on the implant head. As will be described below, regarding these experiments, in all of these tests no bacterial leakage occurred between the implant parts when using seal 100 in accordance with some applications of the present invention.

In a parallel experiment, using same implant type without use of a gasket seal was tested for bacterial leakage. In this experiment bacterial leakage was observed after inserting bacteria into the implant.

1. Experimental Bacteria Loaded to the Implant Using Dual Function Seal 100 without Applying Force to the Implant.

Under aseptic conditions, five μl (1×107 colony forming unit, CFU) of an overnight of E. coli DH5α/pWSK29 Ampr (ampicillin resistance) were loaded into the lower void (portion of the dental implant that is indicated by reference numeral 50 in FIG. 8) of 29 experimental dental implants.

The bacterial-loaded implants were placed into 0.2 ml test tube filled with 600 μl of saline and incubated at 37° C. for 35 days. At 1, 4, 10 and 30 days post bacterial loading (PBL), the saline was sampled and 50 μl from the solution immersing the implants was plated on LB agar plate supplemented with 100 μg/μl Amp plate for viable bacterial count.

None of the dental implant tested showed a bacterial leakage into the medium under static conditions at 37° C. To make sure that viable bacteria are still present in the implant after 30 days and that the absence of bacterial leakage is not the result of bacterial killing, 35 days post loading, three implants were disintegrated, their lower void (portion of the dental implant that is indicated by reference numeral 50 in FIG. 8) was sampled and plated on LB agar plate supplemented with 100 μg/μl Amp plate. Hundreds of CFU were observed after 35 days in the implant, indicating that the absence of bacteria in the exterior saline solution is due to the lack of leakage from the implants (due to the seal of the present invention), and not because of bacteria dying in the implant.

Summary and Conclusion for the Experiment of Bacteria Loaded to the Dental Implant Using Dual Seal 100 without Applying External Force to the Dental Implant:

Under static conditions at 37° C., no bacterial leakage was detected from the modular dental implants MtDI Apex6.5 mm to its immersing medium, despite the survival of the bacteria in the internal space of the implant.

The experiment was successful in all 29 implants that were tested. After 11 days of incubation, there was no bacterial leakage. After 35 days—the bacteria that were inserted into the graft were examined and found alive.

### 2. Experimental Bacteria Loaded to the Implant Using the Dual Function Seal and at an Applied

### Continuous Static Force of 200 Newton Based on an Abutment Attached to the Implant Head at 25 Degrees.

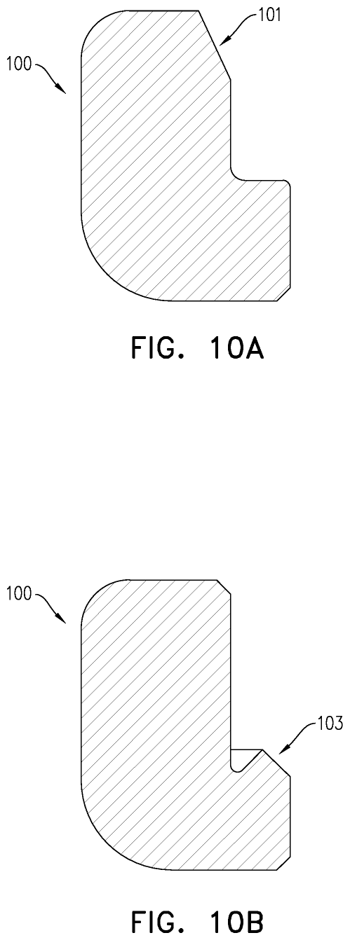

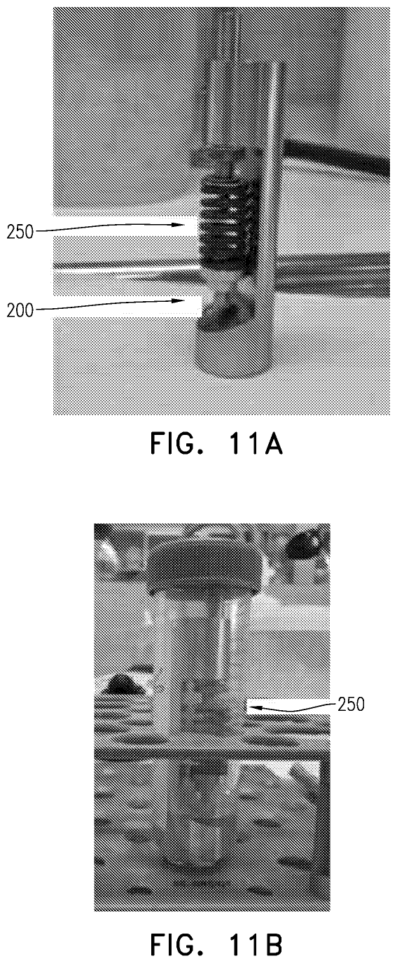

Steps 1-4 below describe the experiment:
1. Exercise constant force on the gasket (seal 100) of about 200 Newtons. The force is applied by a deformed spring (FIG. 11A shows an example of the dental implant 200 and the spring 250 used in experiments performed in accordance with some applications of the present invention). As will be described below, even after applying the fixed power, no bacteria were seen at all. Standard Titanium Abutment H1 25° (STAA-25-1-) Gingival part dimensions—4.7 mm in diameter (D), 1 mm (L) and Abutment Screw-1—supplied by Zeev Implants Ltd.
2. Under aseptic conditions, five μl (1.38×108 colony forming unit, CFU) of an overnight of E. coli DH5α/pWSK29 Ampr (ampicillin resistance) were loaded into the lower void (portion of the dental implant that is indicated by reference numeral 50 in FIG. 8) of 18 experimental dental implants.
3. The bacterial-loaded implants were placed in a specially designed spring that operates a constant force of 200 Newton on Standard Titanium Abutments H1 25° that was inserted on top of the implants (FIG. 11A). It was screwed to the implant by Abutment Screw-1. The screw was tightened and locked by 30 Ncm.
4. The pressed bacterial-loaded implants were placed in 50 ml closed test tubes containing about 3 ml of saline (FIG. 11B) and incubated at 37° C. for 35 days. At 1, 6, 11 and 32 days post bacterial loading (PBL), the saline was sampled and 50 μl from the solution immersing the implants was plated on LB agar plate supplemented with 100 μg/μl Amp plate for viable bacterial count. FIG. 11B shows the experimental setting containing the dental implant and the spring disposed in the 50 ml tube that was used to track the bacterial leakage.

Results: None of the dental implant tested under constant force at 37° C. showed bacterial leakage into the medium. In order to confirm that viable bacteria are still present in the implant after 30 days and that the absence of bacterial leakage is not the result of bacterial death, 35 days post loading, three implants were disintegrated, their lower void (portion of the dental implant that is indicated by reference numeral 50 in FIG. 8) was sampled and plated on LB agar plate supplemented with 100 μg/μl Amp plate.

Hundreds of CFU were observed after 35 days in the implant, indicating that the absence of bacteria in the exterior saline solution is due to the lack of leakage from the implants, and not as a result of the bacteria dying in the implant.

Summary and Conclusion for the Experiment of Bacteria Loaded to the Implant Using the Dual Function Seal at an Applied Continuous Force:

Under constant pressure of 200 Newton at 37° C., no bacterial leakage was detected from the modular dental implants MtDI Apex 6.5 mm to its immersing medium, despite the survival of the bacteria in the internal space of the implant.

Reference is made to FIGS. 1-10B. It is noted that although the dual function seal 100 disclosed herein is described for use with dental implant 200, it is noted that the scope of the present invention includes use of dual function seal 100 with any other type of implant (including any type of dental implant) to seal any interface between parts of the implant. For example, the seal is configured for use with orthopedic implants and/or a cochlear implant or any other type of implant.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. Apparatus for use with a dental implant, the apparatus comprising:
a seal having a cross-section defining a high-load bearing portion and a low-load bearing portion angled in relation to each other, the high-load bearing portion being configured to apply a pressure that is greater than a pressure applied by the low-load bearing portion;
wherein a surface area of the high-load bearing portion is smaller than a surface area of the low-load bearing portion.

2. The apparatus according to claim 1, wherein the high-load bearing portion is configured to apply pressure to the implant along a surface area of the implant that is smaller than a surface area of the implant to which the low-load bearing portion applies pressure to.

3. The apparatus according to claim 1, wherein the high-load bearing portion is configured to apply a pressure that is at least twice the pressure applied by the low-load bearing portion

4. The apparatus according claim 1, wherein the low-load bearing portion is configured to apply pressure to the dental implant along a surface area of the implant such that sealing material of the seal fills pores in the implant.

5. The apparatus according to claim 1, wherein a ratio between the surface area of the low-load bearing portion and the surface area of the high-load bearing portion is 2:1.

6. The apparatus according to claim 1, wherein a ratio between the surface area of the low-load bearing portion and the surface area of the high-load bearing portion is 3:2.

7. The apparatus according to claim 1, wherein a ratio between the surface area of the low-load bearing portion and the surface area of the high-load bearing portion is 4:3.

8. The apparatus according to claim 1, wherein the cross-section of the seal is L-shaped.

9. The apparatus according to claim 1, wherein the seal is sized and shaped to be accommodated between a dental implant and an abutment.

10. The apparatus according to claim 1, wherein the seal is sized and shaped to be accommodated between at least two parts of a dental implant.

11. The apparatus according to claim 1, wherein the seal is sized and shaped to be accommodated between at least two of: dental implants screws, abutments, supra structures or other dental implant parts.

12. The apparatus according to claim 1, wherein the seal is sized and shaped to be accommodated between at least two parts of a medical implant.

13. The apparatus according to claim 1, wherein the seal is sized and shaped to be accommodated between at least two of: medical implant screws, supra-structures, or other medical implant parts.

14. The apparatus according to claim 1, wherein the seal is sized and shaped to be accommodated between at least two implant parts connected by a screw.

15. The apparatus according to claim 1, wherein the seal is sized and shaped to be accommodated between at least two implant parts connected by friction.

16. The apparatus according to claim 1, wherein the seal is sized and shaped to be accommodated between at least two implant parts connected by a shape of connection selected from the group consisting of: an internal connection, an external connection, a hexagonal connection and a conical connection.
